(19) United States
(12) Patent Application Publication
(10) Pub. No.: US 2026/0067525 A1
(43) Pub. Date: Mar. 5, 2026

(54) METHOD OF INFORMATION RECOMMENDATION, COMPUTER DEVICE AND STORAGE MEDIUM

(71) Applicant: Beijing Zitiao Network Technology Co., Ltd., Beijing (CN)

(72) Inventor: Yun LIU, Beijing (CN)

(21) Appl. No.: 19/104,985

(22) PCT Filed: Apr. 25, 2024
(86) PCT No.: PCT/CN2024/089722

§ 371 Date: Feb. 19, 2025

(30) Foreign Application Priority Data
May 10, 2023 (CN) 202310525087.3

(51) Int. Cl. H04N 21/431; G06V 20/40

(52) U.S. Cl. CPC H04N 21/4316; G06V 20/46

(57) ABSTRACT

A method of information recommendation, a computer device and a storage medium are provided. The method includes: playing a target video on an information recommendation page; displaying respective information tags associated with a target entity in the target video, the respective information tags being generated according to at least one information recommendation dimension corresponding to an entity type of the target entity, different entity types corresponding to different information recommendation dimensions; and in response to triggering the information tag, displaying target recommendation information in the information recommendation dimension corresponding to the information tag.

The present application claims priority to Chinese Patent Application No. 202310525087.3, filed on May 10, 2023, the entire disclosure of which is incorporated herein by reference as part of the present application.

### TECHNICAL FIELD

The present disclosure relates to a method and an apparatus of information recommendation, a computer device, and a storage medium.

### BACKGROUND

Various video entities may often appear in a video, especially a recommended video, in which respective recommended entities recommended by a user may often appear. In the process of watching a video, there may be a need to acquire detailed information of a recommended entity. To meet this need, a user watching the video often needs to actively initiate a search for a recommended entity according to the user's knowledge of the recommended entity, so as to obtain a specific search result page.

However, the way of actively initiating a search not only increases the time and complexity of acquiring detailed information of the recommended entity, but also may have a problem that the recommended entity cannot be accurately searched, which affects the search effect.

### SUMMARY

A method and apparatus of information recommendation, a computer device, and a storage medium are at least provided in embodiments of the present disclosure.

According to a first aspect, an embodiment of the present disclosure provides a method of information recommendation, including:
playing a target video on an information recommendation page;
displaying respective information tags associated with a target entity in the target video, where the respective information tags are generated according to at least one information recommendation dimension corresponding to an entity type of the target entity, and different entity types correspond to different information recommendation dimensions; and
in response to triggering an information tag, displaying target recommendation information in an information recommendation dimension corresponding to the information tag.

In a possible implementation, the displaying the respective information tags associated with the target entity in the target video includes:
in response to a plurality of candidate entities being present in the target video, determining the target entity from the plurality of candidate entities according to historical behavior data acquired with user authorization, and displaying the respective information tags associated with the target entity; or,
in response to a plurality of candidate entities being present in the target video, using each of the plurality of candidate entities as the target entity, and respectively displaying entity information of each target entity and respective information tags associated with the target entity.

In a possible implementation, the displaying the respective information tags associated with a target entity in the target video includes:
in response to a plurality of information recommendation dimensions corresponding to the entity type of the target entity being present, switching and displaying, according to playback progress information of the target video, a plurality of information tags associated with the target entity.

In a possible implementation, the displaying the respective information tags associated with the target entity in the target video includes:
in response to a plurality of target entities being present in the target video, displaying the information tag associated with the target entity according to time when the target entity appears in the target video.

In a possible implementation, the in response to triggering the information tag, displaying the target recommendation information in the information recommendation dimension corresponding to the information tag includes:
when a plurality of target entities corresponding to a same entity type are present in the target video that, in response to triggering any of information tags corresponding to the entity type, displaying a recommendation information set in the information recommendation dimension corresponding to the any information tag, where the recommendation information set includes target recommendation information of the plurality of target entities.

In a possible implementation, the candidate entity is determined according to the following steps.
performing duplicate removing processing on respective video frame pictures of the target video according to picture similarity between the respective video frame pictures, to obtain duplicate-removed video frame pictures;
performing image recognition on each of the duplicate-removed video frame pictures respectively, to determine initial entities included in the respective video frame pictures; and
filtering the candidate entities from the initial entities according to a recognition accuracy, a number of occurrences in the target video, and display area in the target video of each of the initial entities.

In a possible implementation, when the initial entity belongs to a preset type, the filtering the candidate entities from the initial entities according to a recognition accuracy, a number of occurrences in the target video, and display area in the target video of each of the initial entities includes:
filtering at least one intermediate entity from the initial entities according to the recognition accuracy, the number of occurrences in the target video, and the display area in the target video of each of the initial entities; and
filtering the candidate entities from the intermediate entities according to a number of entities matching the intermediate entities in a preset entity library.

According to a second aspect, an embodiment of the present disclosure further provides an apparatus of information recommendation, including:
a playing module, configured to play a target video on an information recommendation page;
a first displaying module, configured to display respective information tags associated with a target entity in the target video, the respective information tags being generated according to at least one information recommendation dimension corresponding to an entity type of the target entity, where different entity types correspond to different information recommendation dimensions; and
a second displaying module, configured to, in response to triggering the information tag, display target recommendation information in the information recommendation dimension corresponding to the information tag.

According to a third aspect, an optional implementation of the present disclosure further provides a computer device. The computer device includes a processor and a memory. The memory stores machine-readable instructions executable by the processor. The processor is configured to execute the machine-readable instructions stored in the memory. When the machine-readable instructions are executed by the processor, the steps in the above first aspect or any possible implementation of the first aspect are performed.

According to a fourth aspect, an optional implementation of the present disclosure further provides a computer-readable storage medium. The computer-readable storage medium stores a computer program thereon, and the computer program, when run, performs the steps in the above first aspect or any possible implementation of the first aspect.

For the description of the effects of the above apparatus of information recommendation, computer device, and computer-readable storage medium, reference may be made to the description of the above method of information recommendation, which will not be repeated here.

In order to make the above objects, features, and advantages of the present disclosure more comprehensible, preferred embodiments are described in detail below with reference to the drawings.

### BRIEF DESCRIPTION OF DRAWINGS

In order to illustrate the technical solutions of the embodiments of the present disclosure more clearly, the drawings required for describing the embodiments will be briefly described below. The drawings herein are incorporated in and constitute a part of this specification, and the drawings illustrate embodiments consistent with the present disclosure and, together with the specification, are used to illustrate the technical solutions of the present disclosure. It should be understood that the following drawings only illustrate some embodiments of the present disclosure, and therefore should not be considered as limiting the scope. For those of ordinary skill in the art, other relevant drawings may also be obtained from these drawings without creative effort.

FIG. 1 illustrates a flowchart of a method of information recommendation according to an embodiment of the present disclosure;

FIG. 2 illustrates a schematic diagram of displaying an information tag according to an embodiment of the present disclosure;

FIG. 3 illustrates a schematic diagram of displaying another information tag according to an embodiment of the present disclosure;

FIG. 4 illustrates a schematic diagram of a dimension information display page according to an embodiment of the present disclosure;

FIG. 5 illustrates a schematic diagram of a floating-layer card according to an embodiment of the present disclosure;

FIG. 6 illustrates a schematic diagram of a process of displaying an information recommendation set according to an embodiment of the present disclosure;

FIG. 7 illustrates a schematic diagram of an apparatus of information recommendation according to an embodiment of the present disclosure; and

FIG. 8 illustrates a schematic diagram of a structure of a computer device according to an embodiment of the present disclosure.

### DETAILED DESCRIPTION

To make the objectives, technical solutions, and advantages of the embodiments of the present disclosure clearer, the technical solutions in the embodiments of the present disclosure will be described in detail below with reference to the drawings in the embodiments of the present disclosure. Obviously, the described embodiments are only a part of the embodiments of the present disclosure, rather than all of the embodiments. The components of the embodiments of the present disclosure that are described and illustrated herein may be arranged and designed in various different configurations. Therefore, the following detailed description of the embodiments of the present disclosure is not intended to limit the scope of the claimed present disclosure, but rather represents selected embodiments of the present disclosure. Based on the embodiments of the present disclosure, all other embodiments obtained by those skilled in the art without creative effort fall within the scope of the present disclosure.

In addition, in the embodiments of the present disclosure, the terms “first”, “second”, etc. in the specification and claims and the above drawings are used to distinguish similar objects, but are not necessarily used to describe a specific order or sequence. It should be understood that such data used in the appropriate case can be interchanged, so that the embodiments described herein can be implemented in a sequence other than those illustrated or described herein.

The term “a plurality of” or “a number of” mentioned herein refers to two or more. “And/or”, describes the association relationship of associated objects, and represents that there may be three relationships, for example, A and/or B, which may represent three cases: A alone, A and B at the same time, and B alone. The character “/” generally represents that the associated objects before and after it are in an “or” relationship.

It is found through research that for a video, if there is a need to acquire detailed information of a recommended entity in the video, it is necessary to acquire the detailed information of the recommended entity by actively initiating a search based on the user's knowledge of the recommended entity that has been formed, which not only takes a great deal of time, but also may have a problem that the recommended entity cannot be accurately searched.

Based on the above research, the present disclosure provides a method and an apparatus of information recommendation, a computer device, and a storage medium. By displaying respective information tags associated with a target entity, recommendation information in respective information recommendation dimensions corresponding to an entity type of the target entity can be identified, which improves the diversity of the displayed information. By displaying, in response to triggering an information tag, target recommendation information in an information recommendation dimension corresponding to the information tag, the target recommendation information in an information recommendation dimension of interest can be quickly and efficiently acquired directly using tag information displayed in an information recommendation page, which not only shortens the acquisition path of the target recommendation information and reduces the complexity of acquiring recommendation information, but also can achieve accurate recommendation of information related to the content of the target video. Moreover, since different information tags may correspond to different information recommendation dimensions, information in different dimensions can be acquired using different information tags, which improves the richness of the target recommendation information, and further facilitates better formation of a consumption decision for the target entity using the rich target recommendation information.

The above defects in the solutions are all results obtained by the inventors that has practiced and carefully studied. Therefore, the discovery process of the above problems and the solutions to the above problems proposed by the present disclosure below should all be contributions of the inventors to the present disclosure in the process of the present disclosure.

It should be noted that similar reference numerals and letters in the following drawings represent similar items. Therefore, once an item is defined in a drawing, there is no need to further define and explain it in subsequent drawings.

It may be understood that, before the technical solutions disclosed in the embodiments of the present disclosure are used, users should be informed of the type, usage scope, usage scenario, etc. of the personal information involved in the present disclosure in an appropriate manner and authorization from the users should be obtained according to relevant laws and regulations.

To facilitate understanding of this embodiment, a method of information recommendation disclosed in an embodiment of the present disclosure is first introduced in detail. The execution body of the method of information recommendation provided in the embodiment of the present disclosure is generally a terminal device or other processing device with certain computing power, where the terminal device may be a user equipment (User Equipment, UE), a mobile device, a user terminal, a terminal, a personal digital assistant device (Personal Digital Assistant, PDA), a handheld device, a computer device, etc. In some possible implementations, the method of information recommendation may be implemented by a processor calling computer-readable instructions stored in a memory.

The method information recommendation provided in the embodiment of the present disclosure is described below by taking a computer device as an execution body as an example.

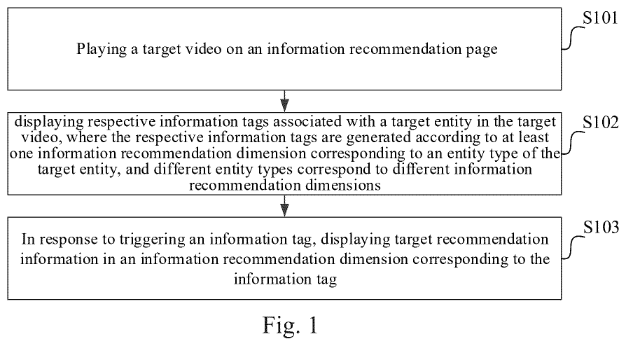

As shown in FIG. 1, FIG. 1 is a flowchart of a method of information recommendation provided in an embodiment of the present disclosure, the method may include the following steps.

S101, playing a target video on an information recommendation page.

Here, the information recommendation page may be a page for displaying and recommending multimedia information. Exemplarily, the information recommendation page may be a video playback page.

The target video may be a video including any video content, for example, the target video may be an information recommendation video, a scenery video, an object introduction video, and the like. The target video may include a plurality of video frames, different video frames may include a same or different target entity, and the target entity may be a physical object, a physical scenery, or the like.

Exemplarily, the target video may be played on the information recommendation page in response to a playing operation for the target video.

S102, displaying respective information tags associated with the target entity in the target video, where the respective information tags are generated according to at least one information recommendation dimension corresponding to an entity type of the target entity, and different entity types correspond to different information recommendation dimensions.

Here, the target entity may be all entities included in a video frame picture of the target video, or may be an entity of a preset type. One target entity may appear in at least one video frame picture in the target video, and the target video may include one or more target entities. Exemplarily, the target entity may be a product in the target video, such as a garment, an electronic device, and a food, or may be a scenery entity in the target video, such as a sea, a temple, a street, a place of interest, and the like.

The information tag is a tag for identifying recommendation information, one information tag may be used to recommend recommendation information in at least one information recommendation dimension, one target entity may be associated with one or more information tags, and different target entities may be associated with different information tags. The recommendation information in the information recommendation dimension has an information attribute indicated by the information recommendation dimension. For example, when the information recommendation dimension is an X X-type video dimension, the recommendation information in the information recommendation dimension may be respective XX-type videos related to the target entity.

The entity type is the type of the target entity. Respective possible entity types may be divided in advance, and after the target entity is obtained, the entity type corresponding to the target entity is determined. One entity type may be associated with at least one information recommendation dimension, and different entity types may be associated with different information recommendation dimensions. Exemplarily, a plurality of information recommendation dimensions may be preset, and an association relationship between each entity type and the associated information recommendation dimension may be established in advance. For example, when the entity type is a garment type, the associated information recommendation dimensions may include an acquisition link dimension, a preferential information dimension, a wearing video dimension, and the like. When the entity type is an electronic device type, the associated information recommendation dimensions may include an evaluation video dimension, an acquisition link dimension, a preferential information dimension, and the like. When the entity type is a food type, the associated information recommendation dimensions may include an acquisition link dimension, a life service tool dimension, a preferential information dimension, a consumption suggestion information dimension, a food science video dimension, and the like. When the entity type is a scenery entity type, the associated information recommendation dimensions may include a travel guide dimension, an accommodation service dimension, a travel service dimension, a scenery evaluation dimension, and the like.

During specific implementation, for each video frame picture, it may be determined whether there is a target entity in the video frame picture. If there is a target entity, respective information recommendation dimensions corresponding to the entity type of the target entity may be determined according to the entity type of the target entity and the association relationship, and then, recommendation information in the information recommendation dimension may be determined, and the information tag corresponding to each information recommendation dimension may be generated. Here, when a plurality of information recommendation dimensions are present, the information tag corresponding to each information recommendation dimension may be generated respectively, that is, one information tag may correspond to one information recommendation dimension. Optionally, one information tag corresponding to a plurality of information recommendation dimensions may also be generated, that is, one information tag may correspond to a plurality of information recommendation dimensions.

After acquiring the information tags corresponding to the respective target entities included in the target video, the information tags may be displayed in a process of playing the target video. For example, in a process of playing the target video, the information tags may be displayed on at least some video frame pictures, or the information tags may be displayed below the target video.

Exemplarily, for a way of displaying the information tag, the information tags may be displayed in the form of an anchor or in the form of a floating layer.

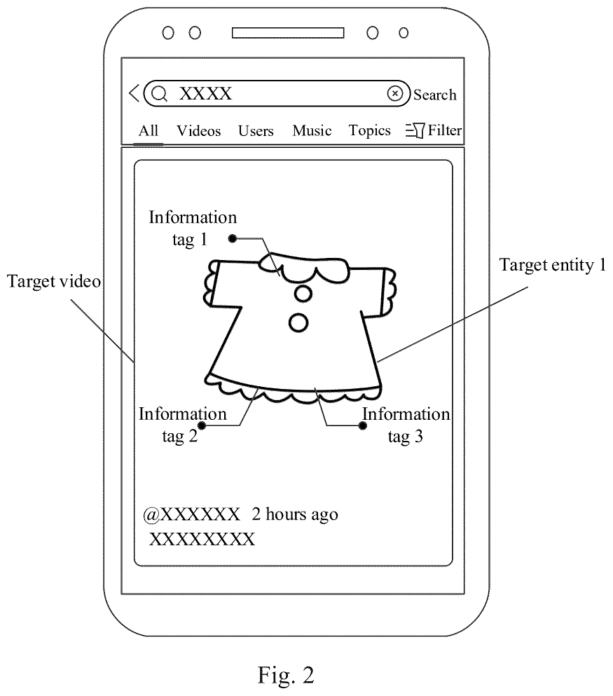

As shown in FIG. 2, FIG. 2 is a schematic diagram of displaying an information tag provided in an embodiment of the present disclosure. The target video is currently played to a video frame picture 1, a target entity 1 in the video frame picture 1 is a garment, and the target entity 1 corresponds to a plurality of information tags in a plurality of information recommendation dimensions (specifically, an information tag 1 corresponding to an acquisition link dimension, an information tag 2 corresponding to a preferential information dimension, and an information tag 3 corresponding to a wearing video dimension), and the three information tags are displayed on the target entity 1 in the form of anchors.

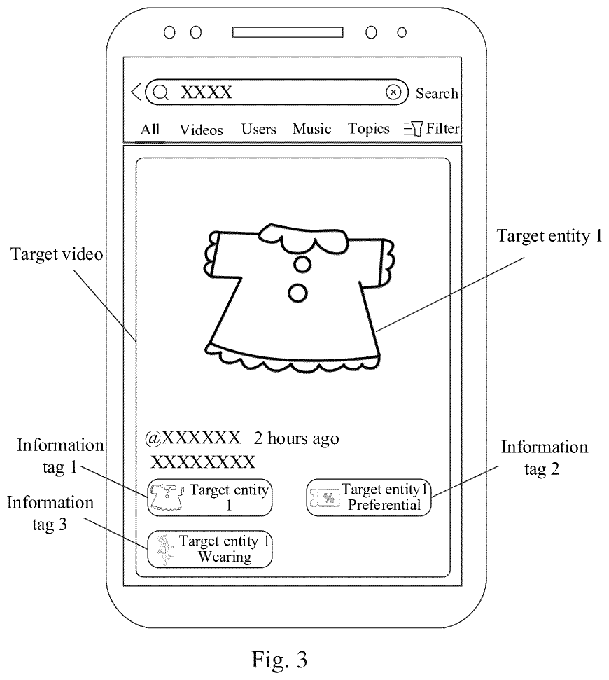

As shown in FIG. 3, FIG. 3 is a schematic diagram of displaying another information tag provided in an embodiment of the present disclosure. The target video is currently played to a video frame picture 1, a target entity in the video frame picture 1 is a garment, and the target entity 1 corresponds to a plurality of information tags in a plurality of information recommendation dimensions (specifically, an information tag 1 corresponding to an acquisition link dimension, an information tag 2 corresponding to a preferential information dimension, and an information tag 3 corresponding to a wearing video dimension), and the three information tags are displayed below the target video in the form of a floating layer. Each information tag may have corresponding tag information (such as a tag picture and a tag name in FIG. 3), where the tag information may be determined according to entity information of the target entity.

S103: in response to triggering an information tag, displaying target recommendation information in an information recommendation dimension corresponding to the information tag.

Here, the target recommendation information may be recommendation information matching the target entity in the information recommendation dimension corresponding to the information tag. The recommendation information may have any information genre, such as a video genre, a picture-text genre, a card genre, and the like. The target recommendation information in one information recommendation dimension may include at least one piece of recommendation information.

Exemplarily, when one information tag corresponds to only one information recommendation dimension, in response to the triggering the information tag, the dimension information display page may be jumped to, and the pieces of target recommendation information in the information recommendation dimension corresponding to the triggered information tag may be displayed on the dimension information display page. Alternatively, in response to the triggering the information tag, the pieces of target recommendation information in the information recommendation dimension corresponding to the triggered information tag may be displayed in the form of a floating-layer card. When one information tag corresponds to a plurality of information recommendation dimensions, the pieces of target recommendation information in the respective information recommendation dimensions may also be displayed in a shuffling manner on the dimension information display page. Similarly, the pieces of target recommendation information in the respective information recommendation dimensions may also be displayed in a shuffling manner on the floating-layer card.

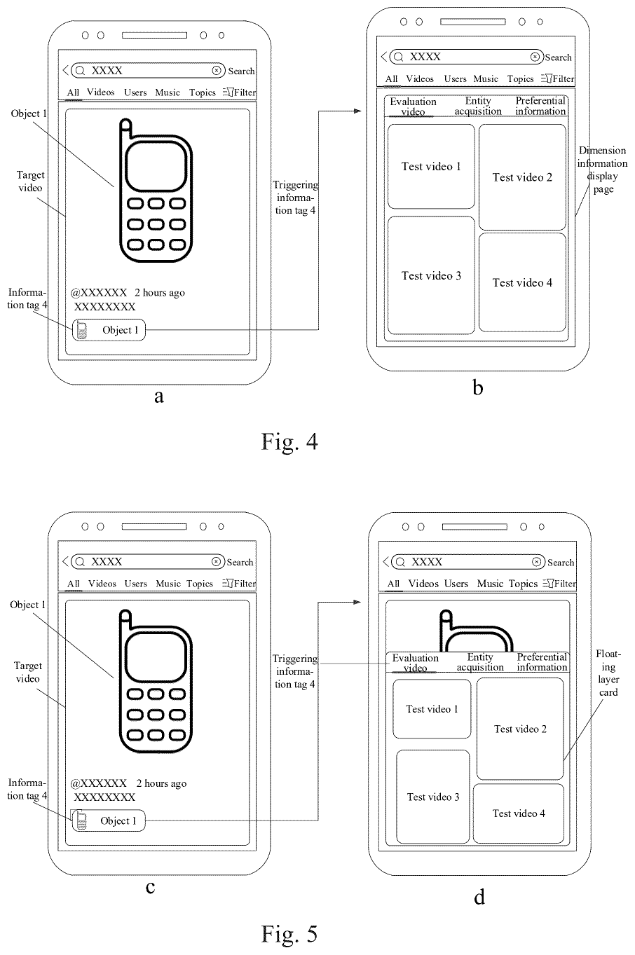

Optionally, when one information tag only corresponds to a plurality of information recommendation dimensions, in response to the triggering the information tag, the dimension information display page may be jumped to, a dimension filter option corresponding to each of the plurality of information recommendation dimensions corresponding to the information tag is displayed on the dimension information display page, and the pieces of target recommendation information in the currently selected dimension filter option are displayed. As shown in FIG. 4, which is a schematic diagram of a dimension information display page provided in an embodiment of the present disclosure, a in FIG. 4 is a schematic diagram of displaying an information tag, where an information tag 4 corresponding to an item 1 (that is, the mobile phone in FIG. 4) is displayed, and the plurality of information recommendation dimensions corresponding to the information tag 4 are an evaluation video dimension, an acquisition link dimension, and a preferential information dimension, respectively. b in FIG. 4 is a schematic diagram of the dimension information display page after the information tag is triggered, where the dimension information display page displays an evaluation video filter option corresponding to the evaluation video dimension, an entity acquisition filter option corresponding to the acquisition link dimension, and a preferential information filter option corresponding to the preferential information dimension. In b of FIG. 4, the currently selected dimension filter option is the evaluation video filter option, and therefore, the pieces of target recommendation information (that is, test videos 1 to 4) in the dimension filter option are also displayed on the dimension information display page.

Similarly, when one information tag only corresponds to a plurality of information recommendation dimensions, in response to the triggering the information tag, the dimension filter options corresponding to the plurality of information recommendation dimensions may also be displayed in the floating-layer card, and the pieces of target recommendation information in the currently selected dimension filter option are displayed. As shown in FIG. 5, which is a schematic diagram of a floating-layer card provided in an embodiment of the present disclosure, c in FIG. 5 is a schematic diagram of displaying an information tag, where an information tag 4 corresponding to an item 1 is displayed, and the plurality of information recommendation dimensions corresponding to the information tag 4 are an evaluation video dimension, an acquisition link dimension, and a preferential information dimension, respectively. d in FIG. 5 is a schematic diagram of the floating-layer card after the information tag is triggered, where the floating-layer card displays an evaluation video filter option corresponding to the evaluation video dimension, an entity acquisition filter option corresponding to the acquisition link dimension, and a preferential information filter option corresponding to the preferential information dimension. In d of FIG. 5, the currently selected dimension filter option is the evaluation video filter option, and therefore, the pieces of target recommendation information (that is, test videos 1 to 4) in the dimension filter option are also displayed in the floating-layer card.

Optionally, when one information tag only corresponds to a plurality of information recommendation dimensions, in response to the triggering the information tag, the dimension filter page may be jumped to, and the plurality of information recommendation dimensions are displayed on the dimension filter page. Then, in response to triggering any information recommendation dimension of the plurality of information recommendation dimensions, the pieces of target recommendation information in the triggered information recommendation dimension are displayed on the dimension information display page. Similarly, in response to the triggering the information tag, the plurality of information recommendation dimensions may also be displayed in the floating-layer card. Then, in response to triggering any information recommendation dimension of the plurality of information recommendation dimensions, the pieces of target recommendation information in the triggered information recommendation dimension are displayed in the floating-layer card.

In an embodiment, the target video often includes a plurality of video frame pictures, and respective video frame pictures often have certain content differences. Therefore, for the target video, a plurality of entities probably appears in the target video. In the case of a plurality of entities, how to display the information tags (that is, how to implement S102 above) may specifically include the following two methods.

In a first method, in response to a plurality of candidate entities being present in the target video, a target entity is determined from the plurality of candidate entities according to historical behavior data acquired with user authorization, and respective information tags associated with the target entity are displayed.

Here, the candidate entity may be an entity object identified from each video frame picture in the target video, respectively. For example, the candidate entity may be a garment 1 and a garment 2 identified from a video frame picture 1, an object 1 identified from a video frame picture 2, and a scenic spot 1 identified from a video frame picture 3.

The historical behavior data is data acquired with user authorization, and may include, for example, entity search data, entity browsing data, entity favorite data, entity acquisition data, and the like.

During specific implementation, after the plurality of candidate entities are identified from the target video, entity content of interest to the user may be determined according to the historical behavior data of the user, and the entity content may be an entity type, a specific entity, and the like. Then, an entity matching the entity content of interest to the user may be filtered from the candidate entities as the target entity.

For example, the entity and the entity type of interest to the user may be determined according to the user's entity favorite data and entity search data. Then, a target entity the same as or similar to the entity of interest to the user may be filtered from the candidate entities, and a target entity matching the entity type of interest to the user may be filtered from the candidate entities according to the entity type of the candidate entity.

Further, after the target entity is determined from the candidate entities, at least one information recommendation dimension corresponding to the target entity and recommendation information in each information recommendation dimension may be determined according to the entity type of the target entity. At the same time, Each information tag associated with the target entity may be generated according to the information recommendation dimension. In this way, the respective information tags associated with the target entity may be acquired, and the respective information tags associated with the target entity are displayed on the information recommendation page.

In this way, by filtering the target entity from the candidate entities, the information tag corresponding to the target entity of interest to the user can be displayed, which improves the targeted performance of the displayed information tag.

In a second method, in response to a plurality of candidate entities being present in the target video, each of the candidate entities is taken as the target entity, and entity information of each target entity and respective information tags associated with the target entity are respectively displayed.

Here, the entity information may be information such as an entity name, an entity picture, and an entity introduction of the target entity.

During specific implementation, when a plurality of candidate entities are present in the target video, each of the candidate entities may be directly taken as the target entity. Then, the entity information of each target entity and the information tags corresponding to each target entity may be acquired. Then, the entity information of each target entity and the respective information tags associated with the target entity may be respectively displayed on the information recommendation page.

In this way, by taking each of the candidate entities as the target entity and displaying the information tags of the respective target entities, it can be ensured that the tag information of the respective entities in the target video is all displayed, which improves the comprehensiveness of the displayed tag information.

In an embodiment, the candidate entity in the target video may be determined according to the following steps.

In step one, duplicate removing processing is performed on the video frame pictures according to picture similarity between the video frame pictures of the target video, to obtain a duplicate-removed video frame picture.

During specific implementation, in the target video, adjacent video frame pictures often have a small difference, and often include a same candidate entity. Therefore, in order to reduce the calculation amount of identifying the candidate entity, the similarity between the video frame pictures may be calculated first, and then the duplicate removing processing may be performed on the video frame pictures with the similarity greater than a preset similarity threshold, so as to obtain the duplicate-removed video frame picture. In this way, for the duplicate-removed video frame pictures, the candidate entities included in different duplicate-removed video frame pictures probably differ.

In step two, image recognition is performed on each of the duplicate-removed video frame pictures, to determine an initial entity included in each of the video frame pictures.

Here, the initial entity may be an entity identified from the duplicate-removed video frame picture.

During specific implementation, image recognition may be performed on each of the duplicate-removed video frame pictures by using a pre-trained visual search model, to obtain the initial entity included in each of the video frame pictures.

Optionally, image recognition may also be performed on each video frame picture in the target video, so as to obtain the initial entity included in each video frame picture. Here, the initial entity in one video frame picture may be empty.

In step three, the candidate entity is filtered from the initial entities according to recognition accuracy, the number of occurrences in the target video, and display area in the target area of each of the initial entities.

Here, the number of occurrences of the initial entity in the target video may be determined according to the number of video frame pictures with the similarity to the duplicate-removed video frame picture including the initial entity greater than a preset similarity threshold. The display area of the initial entity in the target video may be an area occupied by the target entity in the video frame picture.

During specific implementation, the initial entity with the recognition accuracy greater than a preset accuracy, the number of occurrences greater than a preset number of occurrences, and the proportion of the display area in the total area of the video frame picture greater than a preset proportion may be used as the filtered candidate entity.

In an embodiment, when the initial entity belongs to a preset type, step 3 above may also be implemented according to the following sub-steps.

In sub-step one, at least one intermediate entity is filtered from the initial entities according to recognition accuracy, the number of occurrences in the target video, and display area in the target video of each of the initial entities.

Here, the preset type may be set according to experience, which is not specifically limited in the embodiment of the present disclosure. For example, the preset type may be a product type.

Exemplarily, the initial entity with the recognition accuracy greater than the preset accuracy, the number of occurrences greater than the preset number of occurrences, and the proportion of the display area in the total area of the video frame picture greater than the preset proportion may be used as the filtered intermediate entity.

In sub-step two, the candidate entity is filtered from the intermediate entities according to the number of entities matching the intermediate entities in a preset entity library.

Here, the preset entity library includes a plurality of preset entities, and the preset entities may be displayed as the target recommendation information.

During specific implementation, for each intermediate entity, a preset entity matching the preset entity may be recalled from the preset entity library by using a similarity recall method. When the number of preset entities matching the preset entity is greater than a preset number, the intermediate entity may be used as the candidate entity. Otherwise, the intermediate entity is ignored.

In an embodiment, in the target video, one target entity may often appear in a plurality of consecutive video frame pictures, and the entity type of the target entity may correspond to a plurality of information recommendation dimensions. Therefore, for one target entity, when one information recommendation dimension corresponds to one information tag, the target entity may have a plurality of information tags. In the case of a plurality of information tags, S102 above may also be implemented according to the following steps.

In response to a plurality of information recommendation dimensions corresponding to the entity type of the target entity being present, a plurality of information tags associated with the target entity are switched and displayed according to playback progress information of the target video.

Here, the playback progress information is used to indicate the video frame picture that the target video is currently played to.

During specific implementation, when a plurality of information recommendation dimensions corresponding to the entity type of the target entity are present, the target entity may also correspond to a plurality of information tags. According to the playback progress information, it may be determined which frame of the plurality of consecutive video frame pictures including the target entity has been played, while the user may have different needs to know the target entity at different timings when the target entity is displayed in the target video. For example, when the target entity is an electronic product, at an initial moment when the electronic product is displayed, there may be a need to acquire recommendation information of the electronic product in the evaluation video dimension. At an intermediate moment when the electronic product is displayed, there may be a need to acquire recommendation information of the electronic product in the preferential information dimension. At an ending moment when the electronic product is displayed, there may be a need to acquire recommendation information of the electronic product in the acquisition link dimension. Therefore, when the target entity corresponds to a plurality of information tags, after acquiring the plurality of information tags, the plurality of information tags are switched and displayed on the information recommendation page according to the playback progress information of the target video.

Exemplarily, when the target entity is a food 1, the information recommendation dimensions corresponding to the food 1 include an acquisition link dimension, a consumption suggestion information dimension, and a food science video dimension, the acquisition link dimension corresponds to an information tag 5, the consumption suggestion information dimension corresponds to an information tag 6, the food science video dimension corresponds to an information tag 7, and the food 1 corresponds to 15 consecutive video frame pictures, the information tag 7 may be displayed in a process of playing the first 5 video frame pictures corresponding to the food 1, so that the user can acquire a plurality of science videos related to the food 1 according to the information tag 7. The information tag 6 may be displayed in a process of playing the middle 5 video frame pictures corresponding to the food 1, so that the user can acquire suggestion information (such as a recipe, a consumption method, precautions for consumption, etc.) related to the food 1 according to the information tag 6. The information tag 5 may be displayed in a process of playing the last 5 video frame pictures corresponding to the food 1, so that the user can acquire acquisition link information (such as acquisition links of the food 1 from different providers) related to the food 1 according to the information tag 5.

In this way, the information tag is displayed according to the playback progress information of the target video, which can improve the simplicity and rationality of the displayed tag information when each video frame picture is played.

In an embodiment, S102 above may be implemented according to the following steps.

In response to a plurality of target entities being present in the target video, an information tag associated with a target entity is displayed according to time when the target entity appears in the target video.

Here, the time when the target entity appears in the target video is the time when the video frame picture including the target entity appears in the target video. Each target entity may be associated with one or more information tags.

During specific implementation, when a plurality of target entities are present in the target video, for each target entity, the information tags corresponding to the target entity may be displayed in a process of playing the video frame picture including the target entity.

Exemplarily, the target video includes a target entity 1 appearing in video frame pictures 1 to 5, a target entity 2 appearing in video frame pictures 6 to 20, and a target entity 3 appearing in video frame pictures 21 to 30. Thus, in a process of playing the video frame pictures 1 to 5, the information tags associated with the target entity 1 may be displayed in the form of an anchor or a floating layer. In a process of playing the video frame pictures 6 to 20, the information tags associated with the target entity 2 may be displayed in the form of an anchor or a floating layer. In a process of playing the video frame pictures 21 to 30, the information tags associated with the target entity 3 may be displayed in the form of an anchor or a floating layer.

Optionally, when the target entity includes a plurality of target entities, in addition to displaying the information tag of the target entity according to the time when the target entity appears in the target video, the information tags corresponding to the respective target entities may also be displayed in the whole process of playing the target video, that is, the respective information tags corresponding to the respective target entities may be displayed when each video frame picture is played.

In an embodiment, a plurality of target entities corresponding to a same entity type may appear in the target video. In this case, S103 above may be implemented according to the following steps.

When a plurality of target entities corresponding to a same entity type are present in the target video, in response to triggering any information tag corresponding to the entity type, displaying a recommendation information set in an information recommendation dimension corresponding to the information tag, where the recommendation information set includes target recommendation information of the plurality of target entities.

Here, the information tag corresponding to the entity type may specifically be an information tag corresponding to the information recommendation dimension associated with the entity type. For any entity type, when the target entity of the entity type includes a plurality of target entities, for each information recommendation dimension associated with the entity type, recommendation information of the respective target entities in the information recommendation dimension may be aggregated to obtain a recommendation information set corresponding to the information recommendation dimension. One information tag may correspond to one information recommendation dimension, and one information recommendation dimension may correspond to one recommendation information set. The recommendation information set may include a plurality of target entities of a same entity type, and respective pieces of target recommendation information of the plurality of target entities in the information recommendation dimension corresponding to the recommendation information set.

For the plurality of target entities of a same entity type, an information tag corresponding to the target entity in each information recommendation dimension associated with the entity type may be generated (that is, each target entity has one information tag in each information recommendation dimension). Then, after the information tag of any target entity corresponding to any information recommendation dimension is triggered, the recommendation information set in the information recommendation dimension corresponding to the information tag may be displayed.

Exemplarily, entities 1 to 3 correspond to a same entity type, the information recommendation dimensions associated with the entity type include dimensions 1 and 2, and the entities 1 to 3 each have a corresponding information tag in the dimensions 1 and 2 (for example, the entity 1 corresponds to a tag a in the dimension 1 and a tag b in the dimension 2, the entity 2 corresponds to a tag c in the dimension 1 and a tag d in the dimension 2, the entity 3 corresponds to a tag e in the dimension 1 and a tag f in the dimension 2). The dimension 1 corresponds to an information recommendation set 1, and the information recommendation set 1 includes respective pieces of target recommendation information of the entities 1 to 3 in the dimension 1. The dimension 2 corresponds to an information recommendation set 2, and the information recommendation set 2 includes respective pieces of target recommendation information of the entities 1 to 3 in the dimension 2. Then, in response to triggering any information tag corresponding to the dimension 1 (that is, triggering the tag a, c or e), the information recommendation set 1 may be displayed. Or, in response to triggering any information tag corresponding to the dimension 2 (that is, triggering the tag b, d or f), the information recommendation set 2 may be displayed.

Optionally, for the plurality of target entities of a same entity type, for each information recommendation dimension associated with the entity type, one information tag corresponding to the information recommendation dimension may be generated (that is, the plurality of target entities correspond to only one information tag in the information recommendation dimension). After the information tag is triggered, the recommendation information set in the information recommendation dimension corresponding to the information tag may be displayed.

Exemplarily, entities 1 to 3 correspond to a same entity type, the information recommendation dimensions associated with the entity type include dimensions 1 and 2, and the entities 1 to 3 each have a unique information tag in the dimension 1 (a comprehensive tag g) and a unique information tag in the dimension 2 (a comprehensive tag h). The dimension 1 corresponds to an information recommendation set 1, and the information recommendation set 1 includes respective pieces of target recommendation information of the entities 1 to 3 in the dimension 1. The dimension 2 corresponds to an information recommendation set 2, and the information recommendation set 2 includes respective pieces of target recommendation information of the entities 1 to 3 in the dimension 2. Then, in response to triggering the information tag in the dimension 1 (that is, triggering the comprehensive tag g), the information recommendation set 1 may be displayed. Or, in response to triggering the information tag in the dimension 2 (that is, triggering the comprehensive tag h), the information recommendation set 2 may be displayed.

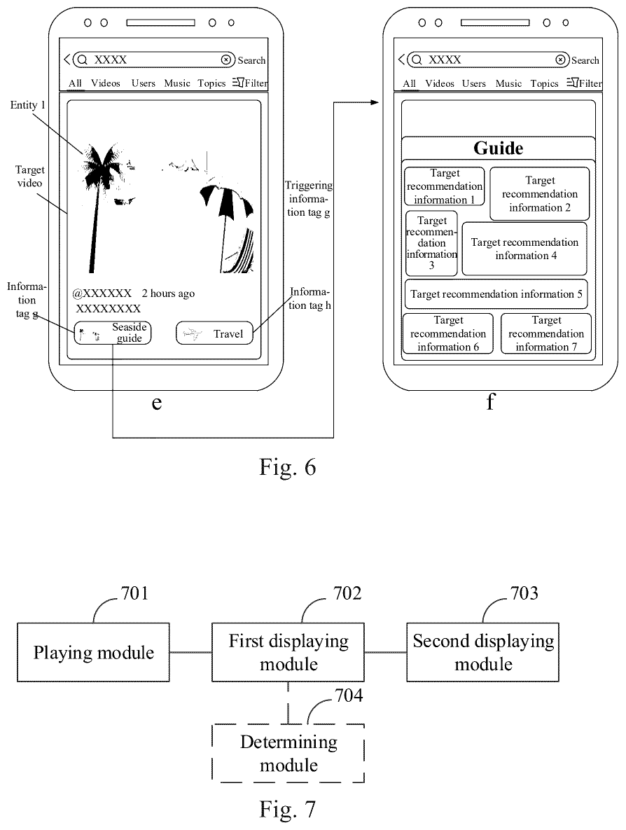

As shown in FIG. 6, which is a schematic diagram of a process of displaying an information recommendation set provided in an embodiment of the present disclosure, e in FIG. 6 is an information recommendation page, where an information tag g (such as a seaside guide in e) and an information tag h (such as a travel in e) are displayed, and the video frame picture currently displayed in the information recommendation page includes only an entity 1 (such as a sea in e), then in response to triggering the information tag g, an information aggregation page shown in f of FIG. 6 may be displayed, where the information aggregation page is displayed on the information recommendation page in the form of a floating-layer card, where an information recommendation set 1 is displayed, and the information recommendation set 1 includes respective pieces of target recommendation information of the entities 1 to 3 in the dimension 1 (such as a guide dimension in f) (as shown in target recommendation information 1 to 7 in FIG. 6, where the target recommendation information 1 and 2 are target recommendation information corresponding to the entity 1, the target recommendation information 3 to 5 are target recommendation information corresponding to the entity 2, and the target recommendation information 6 and 7 are target recommendation information corresponding to the entity 3).

It may be understood by those skilled in the art that, in the above method of the specific implementation, the writing sequence of the steps does not imply a strict execution sequence and does not constitute any limitation to the implementation process, and the specific execution sequence of the steps should be determined according to their functions and possible internal logic.

Based on the same inventive concept, an apparatus of information recommendation corresponding to the method of information recommendation is further provided in an embodiment of the present disclosure. Since the principle of solving the problem by the apparatus in the embodiment of the present disclosure is similar to the above method of information recommendation in the embodiment of the present disclosure, the implementation of the apparatus may refer to the implementation of the method, and the repeated content will not be repeated.

As shown in FIG. 7, which is a schematic diagram of an apparatus of information recommendation provided in an embodiment of the present disclosure, the apparatus includes:
a playing module 701, configured to play a target video on an information recommendation page;
a first displaying module 702, configured to present respective information tags associated with a target entity in the target video, where the respective information tags are generated according to at least one information recommendation dimension corresponding to an entity type of the target entity, and different entity types correspond to different information recommendation dimensions; and
a second displaying module 703, configured to, in response to triggering an information tag, display target recommendation information in the information recommendation dimension corresponding to the information tag.

In a possible implementation, the first displaying module 702, when displaying the respective information tags associated with the target entity in the target video, is configured to:
in response to a plurality of candidate entities being present in the target video, determining the target entity from the plurality of candidate entities according to historical behavior data acquired with user authorization, and displaying the respective information tags associated with the target entity; or,
in response to a plurality of candidate entities being present in the target video, taking each of the candidate entities as the target entity, and respectively displaying entity information of each target entity and respective information tags associated with the target entity.

In a possible implementation, the first displaying module 702, when displaying the respective information tags associated with the target entity in the target video, is configured to:
in response to a plurality of information recommendation dimensions corresponding to the entity type of the target entity being present, switching and displaying, according to playback progress information of the target video, a plurality of information tags associated with the target entity.

In a possible implementation, the first displaying module 702, when displaying the respective information tags associated with the target entity in the target video, is configured to:
in response to a plurality of target entities being present in the target video, displaying an information tag associated with a target entity according to time when the target entity appears in the target video.

In a possible implementation, the second displaying module 703, when displaying the target recommendation information in the information recommendation dimension corresponding to the information tag in response to the triggering the information tag, is configured to:
when a plurality of target entities corresponding to a same entity type are present in the target video, in response to triggering any information tag corresponding to the entity type, displaying a recommendation information set in an information recommendation dimension corresponding to the information tag, where the recommendation information set includes target recommendation information of the plurality of target entities.

In a possible implementation, the apparatus further includes:
a determining module 704, configured to determine the candidate entity according to the following steps:
performing duplicate removing processing on the video frame pictures according to picture similarity between the video frame pictures of the target video, to obtain a duplicate-removed video frame picture;
performing image recognition on each of the duplicate-removed video frame pictures, to determine an initial entity included in each of the video frame pictures; and filtering the candidate entity from the initial entities according to recognition accuracy, the number of occurrences in the target video, and display area in the target video of each of the initial entities.

In a possible implementation, when the initial entity belongs to a preset type, the determining module 704, when filtering the candidate entity from the initial entities according to the recognition accuracy, the number of occurrences in the target video, and the display area in the target video of each of the initial entities, is configured to:
filtering at least one intermediate entity from the initial entities according to the recognition accuracy, the number of occurrences in the target video, and the display area in the target video of each of the initial entities; and
filtering the candidate entity from the intermediate entities according to a number of entities matching the intermediate entities in a preset entity library.

For the description of the processing flow of each module in the apparatus and the interaction flow between the modules, reference may be made to the related description in the above method embodiments, which will not be detailed here.

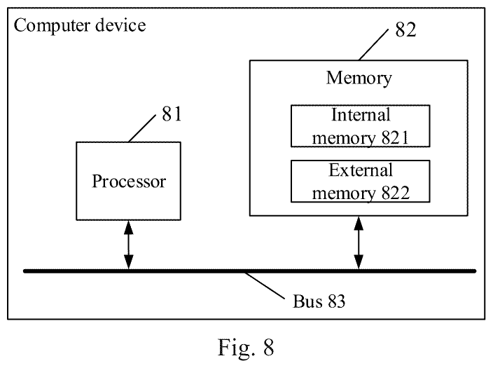

Based on the same technical concept, an embodiment of the present application further provides a computer device. Referring to FIG. 8, which is a schematic diagram of a structure of a computer device provided in an embodiment of the present application, the computer device includes:
a processor 81, a memory 82, and a bus 83. The memory 82 stores machine-readable instructions executable by the processor 81. The processor 81 is configured to execute the machine-readable instructions stored in the memory 82. When the machine-readable instructions are executed by the processor 81, the processor 81 performs the following steps: S101, playing a target video on an information recommendation page; S102, displaying respective information tags associated with a target entity in the target video, where the respective information tags are generated according to at least one information recommendation dimension corresponding to an entity type of the target entity, and different entity types correspond to different information recommendation dimensions; and S103, in response to triggering an information tag, displaying target recommendation information in an information recommendation dimension corresponding to the information tag.

The memory 82 includes an internal memory 821 and an external memory 822. The internal memory 821 is also referred to as a built-in storage, and is configured to temporarily store operation data in the processor 81 and data exchanged with an external memory 822 such as a hard disk. The processor 81 exchanges data with the external memory 822 through the internal memory 821. When the computer device is running, the processor 81 communicates with the memory 82 through the bus 83, so that the processor 81 executes the execution instructions mentioned in the above method embodiments.

An embodiment of the present disclosure further provides a computer-readable storage medium. The computer-readable storage medium stores a computer program which, when run by a processor, performs the steps of the method of information recommendation according to the above method embodiments. The storage medium may be a volatile or non-volatile computer-readable storage medium.

A computer program product of the method of information recommendation provided in an embodiment of the present disclosure includes a computer-readable storage medium storing program codes, where instructions included in the program codes may be used to perform the steps of the method of information recommendation according to the above method embodiments, which may be specifically referred to the above method embodiments, and will not be repeated here.

The computer program product may be embodied in hardware, software, or a combination of the hardware and software. In an optional embodiment, the computer program product is embodied as a computer storage medium. In another optional embodiment, the computer program product is embodied as a software product, such as a software development kit (Software Development Kit, SDK), etc.

It may be clearly understood by those skilled in the art that, for the convenience and simplicity of description, the specific working process of the apparatus described above may refer to the corresponding process in the foregoing method embodiments, which will not be repeated here. In the several embodiments provided in the present disclosure, it should be understood that the disclosed apparatus and method may be implemented in other manners. The above-described apparatus embodiments are only schematic, for example, the division of the units is only a logical function division, and there may be other division manners in actual implementation. For another example, a plurality of units or components may be combined, or some features may be ignored, or not executed. In addition, the mutual coupling or direct coupling or communication connection shown or discussed may be indirect coupling or communication connection through some communication interfaces, apparatus or units, and may be electrical, mechanical or other forms.

The units described as separate parts may or may not be physically separated, and the parts displayed as units may or may not be physical units, that is, may be located in one place, or may be distributed to a plurality of network units. Some or all of the units may be selected according to actual needs to achieve the purpose of the solution of this embodiment.

In addition, the functional units in the various embodiments of the present disclosure may be integrated into one processing unit, or each unit may exist independently physically, or two or more units may be integrated into one unit.

If the functions are implemented in the form of software functional units and sold or used as independent products, the functions may be stored in a non-volatile computer-readable storage medium executable by a processor. Based on such understanding, the technical solutions of the present disclosure, or the part that contributes to the prior art, or the part of the technical solutions may be embodied in the form of a software product, which is stored in a storage medium and includes several instructions for causing a computer device (which may be a personal computer, a server, or a network device, etc.) to perform all or part of the steps of the methods according to the embodiments of the present disclosure. The foregoing storage medium includes various media that can store program codes, such as a USB flash drive, a mobile hard disk, a read-only memory (Read-Only Memory, ROM), a random-access memory (Random Access Memory, RAM), a magnetic disk, or an optical disk.

If the technical solutions of the present application involve personal information, a product applying the technical solutions of the present application has clearly informed of the personal information processing rules and obtained the individual's autonomous consent before processing the personal information. If the technical solutions of the present application involve sensitive personal information, the product applying the technical solutions of the present application has obtained the individual's separate consent and meets the requirement of “express consent” before processing the sensitive personal information. For example, at a personal information collection apparatus such as a camera, a clear and conspicuous identification is set to inform that the personal information collection range has been entered and the personal information will be collected. If an individual voluntarily enters the collection range, it is deemed that the individual consents to the collection of the personal information. Alternatively, in the case where a personal information processing rule is informed by using a conspicuous identification/information on a personal information processing apparatus, personal authorization is obtained by means of pop-up information or asking the individual to upload the personal information by the individual. The personal information processing rule may include information such as a personal information processor, a purpose of personal information processing, a processing manner, and a type of personal information being processed.

Finally, it should be noted that the above embodiments are only specific implementations of the present disclosure, and are used to illustrate the technical solutions of the present disclosure, but not to limit the technical solutions. The protection scope of the present disclosure is not limited to the above embodiments. Although the present disclosure has been described in detail with reference to the foregoing embodiments, those of ordinary skill in the art should understand that any person skilled in the art can still modify or easily conceive changes to the technical solutions described in the foregoing embodiments, or equivalently replace some technical features thereof, within the technical scope disclosed in the present disclosure. These modifications, changes or replacements do not make the essence of the corresponding technical solutions deviate from the spirit and scope of the technical solutions of the embodiments of the present disclosure, and should be covered by the protection scope of the present disclosure. Therefore, the protection scope of the present disclosure should be subject to the protection scope of the claims.

1. A method of information recommendation, comprising:
playing a target video on an information recommendation page;
displaying respective information tags associated with a target entity in the target video, the respective information tags being generated according to at least one information recommendation dimension corresponding to an entity type of the target entity, wherein different entity types correspond to different information recommendation dimensions; and
in response to triggering the information tag, displaying target recommendation information in the information recommendation dimension corresponding to the information tag.

2. The method according to claim 1, wherein the displaying respective information tags associated with a target entity in the target video comprises:
in response to a plurality of candidate entities being present in the target video, determining the target entity from the plurality of candidate entities according to historical behavior data acquired with user authorization, and displaying the respective information tags associated with the target entity; or,
in response to a plurality of candidate entities being present in the target video, using each of the plurality of candidate entities as the target entity, and respectively displaying entity information of each target entity and respective information tags associated with each target entity.

3. The method according to claim 1, wherein the displaying respective information tags associated with a target entity in the target video comprises:
in response to a plurality of information recommendation dimensions corresponding to the entity type of the target entity being present, switching and displaying, according to playback progress information of the target video, a plurality of information tags associated with the target entity.

4. The method according to claim 1, wherein the displaying respective information tags associated with a target entity in the target video comprises:
in response to a plurality of target entities being present in the target video, displaying the information tag associated with the target entity according to time when the target entity appears in the target video.

5. The method according to claim 1, wherein, in response to triggering the information tag, displaying the target recommendation information in the information recommendation dimension corresponding to the information tag, comprises:
when a plurality of target entities corresponding to a first entity type are present in the target video, in response to triggering any information tag of the information tags corresponding to the first entity type, displaying a recommendation information set in the information recommendation dimension corresponding to the any information tag, wherein the recommendation information set comprises the target recommendation information of the plurality of target entities.

6. The method according to claim 2, wherein the candidate entity is determined according to following steps:
performing duplicate removing processing on respective video frame pictures of the target video according to picture similarity between the respective video frame pictures, to obtain duplicate-removed video frame pictures;
performing image recognition on each of the duplicate-removed video frame pictures respectively, to determine initial entities comprised in the respective video frame pictures; and
filtering the candidate entities from the initial entities according to a recognition accuracy, a number of occurrences in the target video, and display area in the target video of each of the initial entities.

7. The method according to claim 6, wherein when the initial entities belong to a preset type, the filtering the candidate entities from the initial entities according to a recognition accuracy, a number of occurrences in the target video, and display area in the target video of each of the initial entities comprises:
filtering at least one intermediate entity from the initial entities according to the recognition accuracy, the number of occurrences in the target video, and the display area in the target video of each of the initial entities; and
filtering the candidate entity from the intermediate entity according to a number of entities matching the intermediate entity in a preset entity library.

8. (canceled)

9. A computer device, comprising: at least one processor and at least one memory, wherein the at least one memory stores machine-readable instructions being capable of being executed by the processor, the processor is configured to execute the machine-readable instructions stored in the at least one memory, and when the machine-readable instructions are executed by the at least one processor, the at least one processor performs a method of information recommendation, which comprises:
playing a target video on an information recommendation page;
displaying respective information tags associated with a target entity in the target video, the respective information tags being generated according to at least one information recommendation dimension corresponding to an entity type of the target entity, wherein different entity types correspond to different information recommendation dimensions; and
in response to triggering the information tag, displaying target recommendation information in the information recommendation dimension corresponding to the information tag.

10. A non-transitory computer-readable storage medium, wherein the computer-readable storage medium stores aat least one computer program thereon, and when the at least one computer program is run by a computer device, the computer device performs a method of information recommendation, which comprises:
playing a target video on an information recommendation page;
displaying respective information tags associated with a target entity in the target video, the respective information tags being generated according to at least one information recommendation dimension corresponding to an entity type of the target entity, wherein different entity types correspond to different information recommendation dimensions; and
in response to triggering the information tag, displaying target recommendation information in the information recommendation dimension corresponding to the information tag.

11. The method according to claim 2, wherein the displaying respective information tags associated with a target entity in the target video comprises:
in response to a plurality of information recommendation dimensions corresponding to the entity type of the target entity being present, switching and displaying, according to playback progress information of the target video, a plurality of information tags associated with the target entity.

12. The method according to claim 2, wherein the displaying respective information tags associated with a target entity in the target video comprises:
in response to a plurality of target entities being present in the target video, displaying the information tag associated with the target entity according to time when the target entity appears in the target video.

13. The method according to claim 2, wherein, in response to triggering the information tag, displaying the target recommendation information in the information recommendation dimension corresponding to the information tag, comprises:
when a plurality of target entities corresponding to a first entity type are present in the target video, in response to triggering any information tag of the information tags corresponding to the first entity type, displaying a recommendation information set in the information recommendation dimension corresponding to the any information tag, wherein the recommendation information set comprises the target recommendation information of the plurality of target entities.

14. The method according to claim 3, wherein, in response to triggering the information tag, displaying the target recommendation information in the information recommendation dimension corresponding to the information tag, comprises:
when a plurality of target entities corresponding to a first entity type are present in the target video, in response to triggering any information tag of the information tags corresponding to the first entity type, displaying a recommendation information set in the information recommendation dimension corresponding to the any information tag, wherein the recommendation information set comprises the target recommendation information of the plurality of target entities.

15. The method according to claim 4, wherein, in response to triggering the information tag, displaying the target recommendation information in the information recommendation dimension corresponding to the information tag, comprises:
when a plurality of target entities corresponding to a first entity type are present in the target video, in response to triggering any information tag of the information tags corresponding to the first entity type, displaying a recommendation information set in the information recommendation dimension corresponding to the any information tag, wherein the recommendation information set comprises the target recommendation information of the plurality of target entities.

16. The computer device according to claim 9, wherein the displaying respective information tags associated with a target entity in the target video comprises:
in response to a plurality of candidate entities being present in the target video, determining the target entity from the plurality of candidate entities according to historical behavior data acquired with user authorization, and displaying the respective information tags associated with the target entity; or,
in response to a plurality of candidate entities being present in the target video, using each of the plurality of candidate entities as the target entity, and respectively displaying entity information of each target entity and respective information tags associated with each target entity.

17. The computer device according to claim 9, wherein the displaying respective information tags associated with a target entity in the target video comprises:
in response to a plurality of information recommendation dimensions corresponding to the entity type of the target entity being present, switching and displaying, according to playback progress information of the target video, a plurality of information tags associated with the target entity.

18. The computer device according to claim 9, wherein the displaying respective information tags associated with a target entity in the target video comprises:
in response to a plurality of target entities being present in the target video, displaying the information tag associated with the target entity according to time when the target entity appears in the target video.

19. The computer device according to claim 9, wherein, in response to triggering the information tag, displaying the target recommendation information in the information recommendation dimension corresponding to the information tag, comprises:
when a plurality of target entities corresponding to a first entity type are present in the target video, in response to triggering any information tag of the information tags corresponding to the first entity type, displaying a recommendation information set in the information recommendation dimension corresponding to the any information tag, wherein the recommendation information set comprises the target recommendation information of the plurality of target entities.

20. The computer device according to claim 16, wherein the candidate entity is determined according to following steps:
performing duplicate removing processing on respective video frame pictures of the target video according to picture similarity between the respective video frame pictures, to obtain duplicate-removed video frame pictures;
performing image recognition on each of the duplicate-removed video frame pictures respectively, to determine initial entities comprised in the respective video frame pictures; and
filtering the candidate entities from the initial entities according to a recognition accuracy, a number of occurrences in the target video, and display area in the target video of each of the initial entities.

21. The computer device according to claim 20, wherein when the initial entities belong to a preset type, the filtering the candidate entities from the initial entities according to a recognition accuracy, a number of occurrences in the target video, and display area in the target video of each of the initial entities comprises:
filtering at least one intermediate entity from the initial entities according to the recognition accuracy, the number of occurrences in the target video, and the display area in the target video of each of the initial entities; and
filtering the candidate entity from the intermediate entity according to a number of entities matching the intermediate entity in a preset entity library.
